(19) United States
(12) Patent Application Publication
(10) Pub. No.: US 2013/0239395 A1
(43) Pub. Date: Sep. 19, 2013

(54) MULTI-PART LOCKING NUT

(71) Applicants: Gary L. Schuster, Huron, OH (US); John William Springer, Huron, OH (US)

(72) Inventors: Gary L. Schuster, Huron, OH (US); John William Springer, Huron, OH (US)

(73) Assignee: Industrial Nut Corp., Sandusky, OH (US)

(21) Appl. No.: 13/832,959

(22) Filed: Mar. 15, 2013

Related U.S. Application Data
(60) Provisional application No. 61/611,850, filed on Mar. 16, 2012.

(51) Int. Cl. F16B 39/04

(52) U.S. Cl. CPC F16B 39/04
USPC 29/464; 411/209

(57) ABSTRACT

A multi-part locking nut assembly has a lock nut having a raised center portion and a flange having a plurality of holes therethrough, a washer having a protrusion which is matingly received by a notch in a spindle; the washer having a plurality of holes therethrough; and at least one locking pin which is slidably received by one of the plurality of holes of the nut and one of the plurality of holes of the washer; and a resilient biasing member which retains the locking pin in place.

### CLAIM OF PRIORITY

This application claims priority from Provisional Application Ser. No. 61/611,850, filed on Mar. 16, 2012, the entirety of which is hereby incorporated by reference.

### BACKGROUND OF THE DISCLOSURE

Locking fasteners and locking fastener assemblies are used to prevent loosening of a threaded fastener in a fastener joint. There are many types of threaded joints in which loosening of a fastener is undesirable. One example to which the principles of the present disclosure may be applied is an axle assembly of a vehicle, including automobiles, heavy trucks, trailers or other transportation devices as well as construction equipment.

In a typical axle assembly, axle bearings are supported between an axle or spindle and a wheel hub or spindle support to permit rotation of a vehicle wheel. An axle bearing nut is used to hold the components together. Usually, the axle bearing assembly is encased with grease and sealed so that outside contaminates, which can lead to premature bearing wear and failure, cannot enter the bearing assembly. Moreover, in order to extend bearing life, the nut must be installed properly and tightened to the proper torque to avoid excessive axial bearing load or, alternatively, excessive free play. In addition, after assembly, it is important to prevent loosening of the axle bearing nut to avoid bearing failure or even the dangerous loss of a wheel.

Existing locking assemblies provide a limited number of adjustment positions. As a result, if an installer is not careful during alignment of the pin with the washer, part of the pin could scrape against the sides of the washer, causing metal shavings to fall with the sealed bearing assembly. Thus, there exists a need for a locking nut assembly which has virtually limitless alignment positions using holes instead of slots which also prevents misalignment of a pin with a washer.

There is also a need for a lock nut assembly which does not require a sight gage for alignment.

Other aspects of the disclosure will become apparent upon a further reading of the following detailed description taken in conjunction with the drawings.

### SUMMARY OF THE DISCLOSURE

In accordance with one aspect of the disclosure, a multi-part locking nut assembly has a nut having a raised center portion and a flange having a plurality of holes thereof. A washer has a protrusion which is matingly received by a notch in a spindle. The washer has a plurality of holes therethrough. At least one locking pin is slidably received by one of the plurality of holes of the nut and one of the plurality of holes of the washer. A resilient biasing member retains the locking pin in place.

A method of assembling a lock nut includes the steps of assembling a washer on a spindle by aligning a protrusion of the washer with a groove on the spindle; threading a lock nut onto the spindle until the nut contacts the washer; aligning at least one hole in the nut with at least one hole in the washer; inserting a locking pin through a hole of the washer and the hole of the lock nut; and inserting a resilient biasing member onto the nut to retain the locking pin onto the nut and washer.

### BRIEF DESCRIPTION OF THE DRAWINGS

FIG. 1 is a perspective view of a locking nut assembly in an assembled configuration in accordance with a preferred embodiment of the present invention;

FIG. 2 is an exploded view of the lock nut assembly of FIG. 1;

FIG. 3 is an exploded perspective view of the lock nut assembly of FIG. 1;

FIG. 4A is a top plan view of a lock nut of FIG. 1;

FIG. 4B is a side elevational view of the lock nut of FIG. 4A;

FIG. 5A is a top plan view of a lock washer of FIG. 1;

FIG. 5B is a side elevational view of the lock washer of FIG. 5A;

FIG. 6A is a top plan view of a snap-ring for the lock nut assembly of FIG. 1;

FIG. 6B is a side elevational view of the snap ring of FIG. 6A;

FIG. 7A is a top plan view and a side elevational view of a pin or pin used in the assembly of FIG. 1;

FIG. 8A is a top plan view of a snap ring for the assembly of FIG. 1 in accordance with another aspect of the disclosure; and

FIG. 8B is a side elevational view of the snap ring of FIG. 8A.

### DETAILED DESCRIPTION OF THE DISCLOSURE

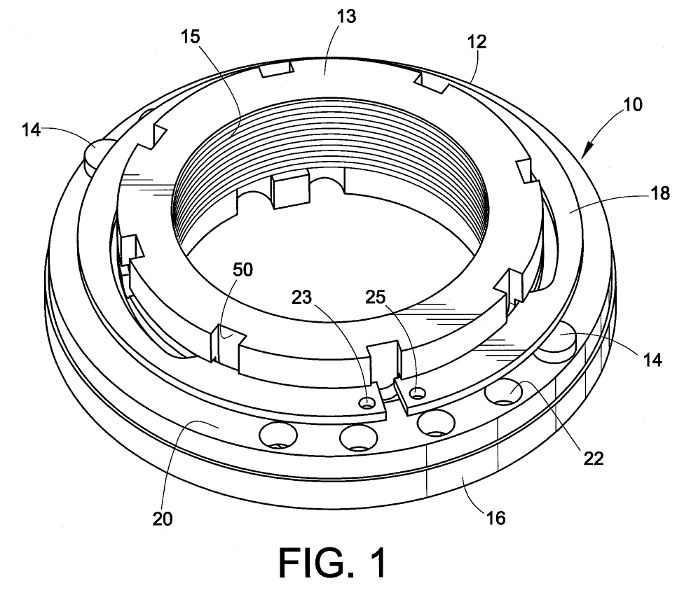

Referring to the figures, FIGS. 1-8 illustrate a locking nut assembly in accordance with a preferred embodiment of the disclosure. These figures show one example of the assembly only and other dimensions and sizes are contemplated by the disclosure.

Referring now to FIG. 1, a perspective view of the components of one embodiment of the locking fastener assembly 10 of the present invention in an assembled configuration is shown. The locking fastener assembly 10 includes a lock nut 12, at least one locking pin 14 (preferably two pins), a retainer washer 16, and a snap ring 18.

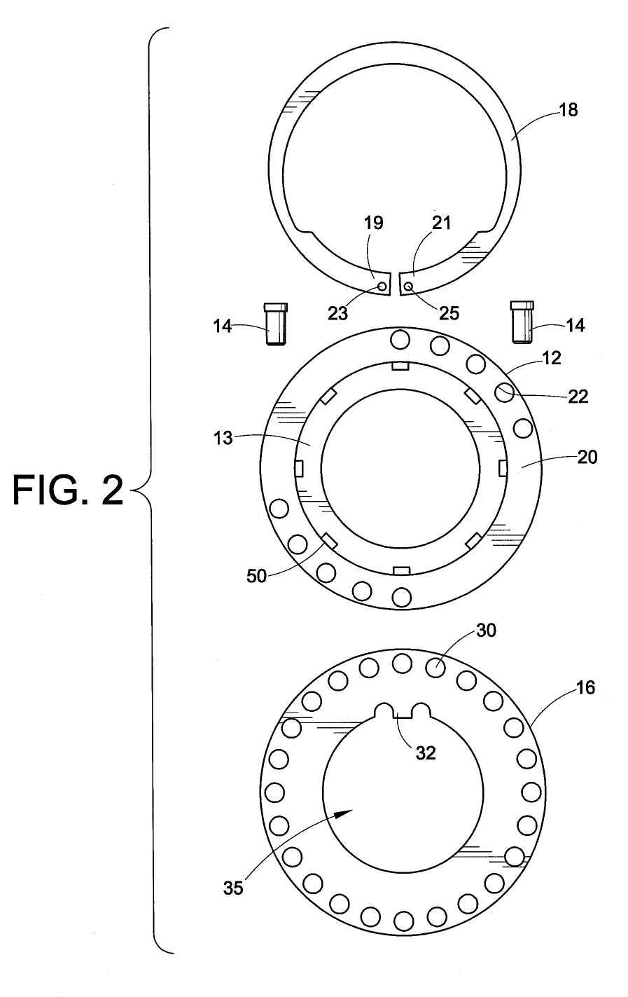

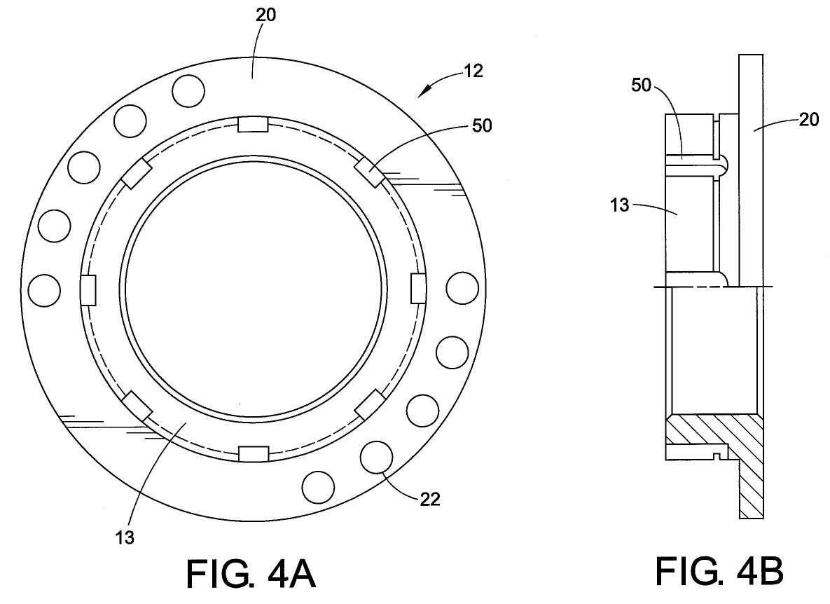

Referring now to FIGS. 2 and 4, the nut 12 has a flange 20 with multiple through holes 22, wherein the locking pins or pins 14 are received. The nut is shown as having ten through holes 22 (five on each side), but other numbers and positions of holes are contemplated by the disclosure. The nut 12 also can have a raised central portion 13 having internal female threads 15 formed therein. In order to give the nut 12 high shear strength, it is preferred that nut 12 is made out of a metal with HRC 28-32 (preferably AISI 1141 or 1045 alloy steel). However, other alloys of steel and hardnesses are contemplated by the disclosure.

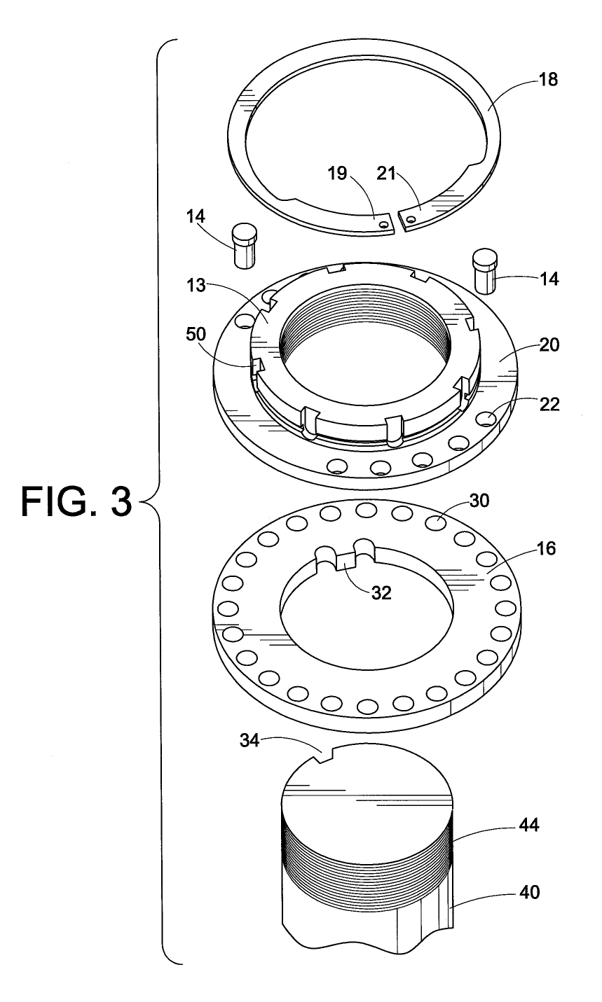

FIGS. 4A and 4B show the lock nut 12 having a plurality of notches 50 formed in raised portion 13 that receive a wrench or other tightening tool (not shown) for tightening and loosening the nut 12 by rotation clockwise or counter-clockwise on the threads formed on spindle 40 (FIG. 3). Notches or grooves 50 also receive the snap ring 18.

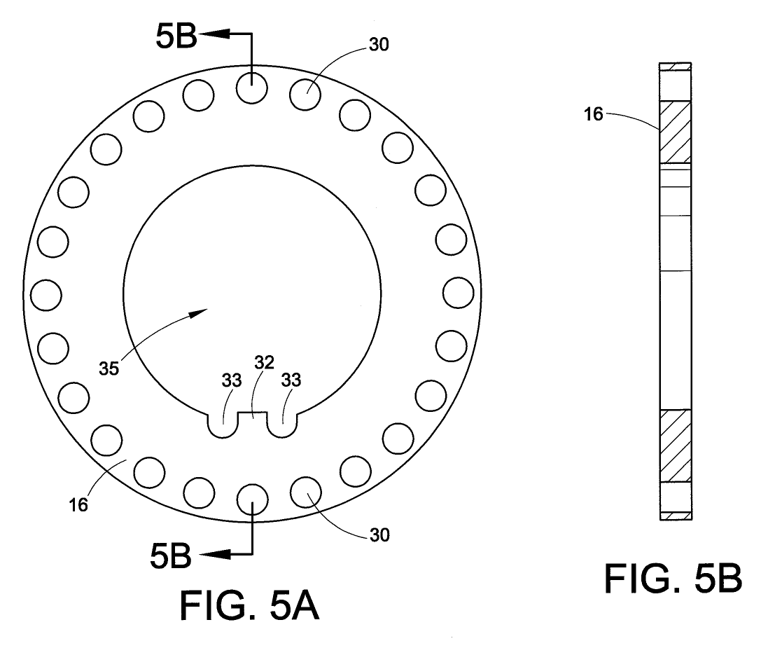

As shown in FIGS. 2 and 5A and 5B, the retaining washer 16 has a tab or key 32 formed by two recesses or grooves 33 which protrudes at least slightly into the inner center opening 35 of the washer which is matingly engageable with a corresponding axial slot or key way 34 in spindle 40 (FIG. 3), the spindle 40 also having axial threads 44. When the key 32 engages with slot 34, the washer 16 is prohibited from rotational movement around spindle, but is allowed to move axially in a longitudinal direction along slot 34. The retaining washer 16 also includes holes 30 spaced evenly (about 15° apart) around the periphery of the retaining washer 16. In a preferred embodiment, there are 24 such holes. However, one with skill in the art will appreciate that there can be fewer or greater holes, depending on the particular use of the locking fastener assembly 10 and the desired amount of locking locations. The holes are of such dimensions (such as about 0.3 inches in diameter or so) that a locking pin 14 can pass therethrough. It is preferred that the retaining washer 16 comprise alloy steel that can be oil quenched and tempered. Various alloys of steel are contemplated by the disclosure.

Preferably, to allow for proper alignment, one of the holes 22 in the nut flange 20 is closely aligned with one of the holes 30 formed in washer 16. Due to the large number (24) of holes 30 in the washer, a virtually limitless number of alignment positions can be achieved by aligning a hole 22 in the nut with a hole 30 in the washer. Furthermore, the holes 30 are sized such that slight misalignment between holes 30 and holes 22 is compensated for and the pin 14 is able to slide through both holes. The axial movement or alignment is capable of adjustment of less than 0.0005 inch.

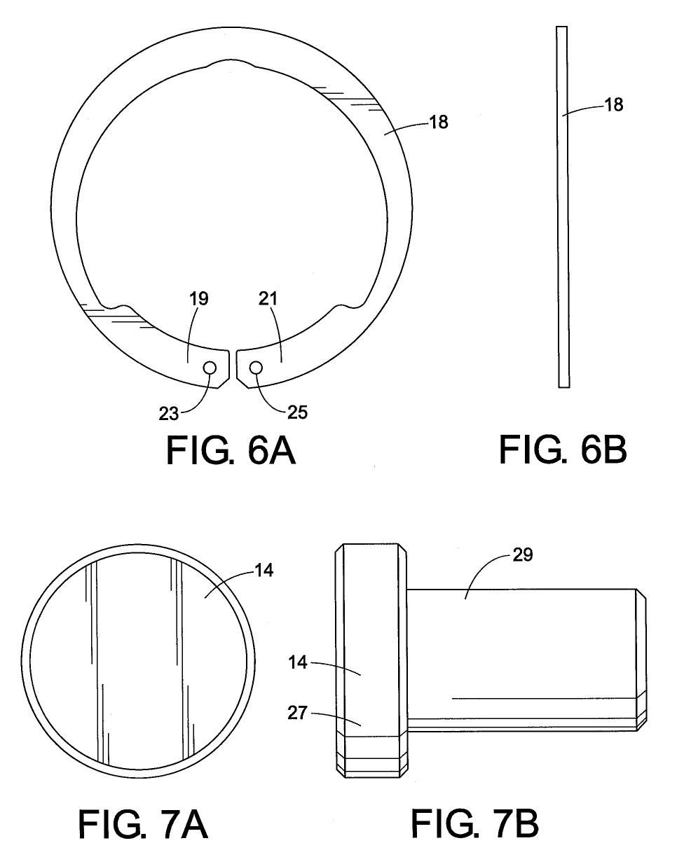

Referring now to FIGS. 2 and 6A-6B, snap-ring 18 is used to retain the locking pins or pins 14 in place. The snap-ring has two opposed ends 19 and 21 which are resiliently biased to a “closed” position as seen in FIG. 6A. To “open” the ring, a tool is inserted into openings 23, 25 formed in ends 19, 21 to pry the ends apart to slide the ring over portion 13 of nut 12. The snap-ring has a thickness of about 0.100 inches and is preferably fabricated of high carbon spring steel with a hardness of 45-50 HRC. However, other hardnesses of steel are also contemplated by the disclosure.

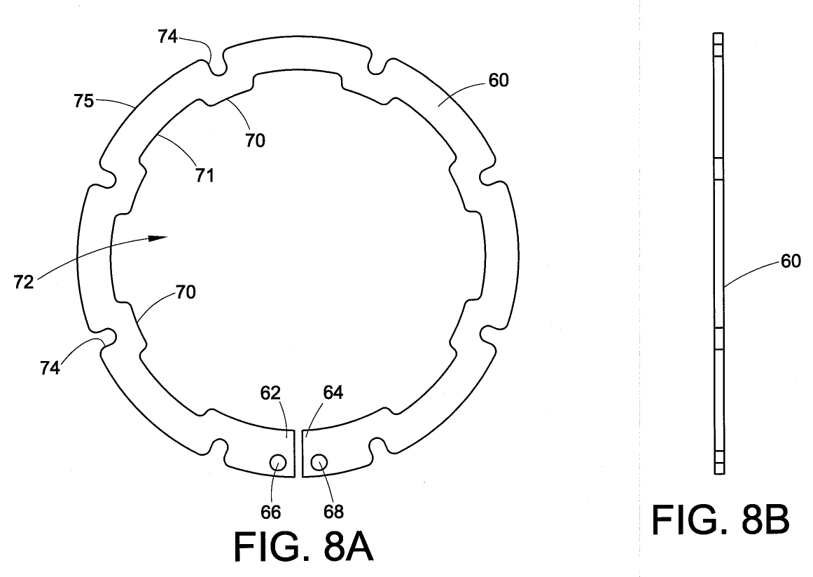

Referring now to FIGS. 8A and 8B, a snap ring 60 in accordance with another embodiment of the disclosure is shown. The snap ring 60 has two opposed ends 62, 64 which are resiliently biased to the “closed” position shown in FIG. 8A. To “open” the rings, a tool is inserted into openings 66, 68 found in ends 62, 64 to pry the ends apart to slide rings over portion 13 of nut 12. The snap ring has a thickness of about 0.100 inches and is preferably fabricated of high carbon spring steel with a hardness of 45-50 HRC. However, other hardnesses of steel are also contemplated by the disclosure. The snap ring 60 has a plurality of inner ridges 70 formed on inner edge 71 extending into centered opening 72 and a plurality of notches or grooves 74 formed on outer edge 75. The ridges and grooves are preferably in alignment with each other and can be evenly spread along the circumference of the snap ring. The ridges and grooves are used to facilitate bending or stretching of the snap ring to slide the ring over portion 13 of nut 12.

Referring now to FIGS. 2 and 7A-7B, locking pin or pin 14 has a head 27 and body 29 and is preferably fabricated of alloy steel preferably having a hardness of RC 40-46. However, other hardnesses are contemplated by the disclosure. The pin can be zinc phosphate and oil coated.

Operation of the present disclosure is accomplished as follows:

First, the washer 16 is assembled on the spindle 40, aligning the washer key 32 with the keyway 34 on the spindle. The flanged nut 12 (flanged side to the keyed washer) is threaded on the spindle until the nut contacts the surface of the washer. The nut is torqued to achieve required torque or bearing preload.

Alignment of holes 22 in the flange of the locknut with the holes 30 in the lock washer is then checked. If alignment is correct, two pins 14 are inserted in the opposing aligned holes 22, 30. The snap ring 18 is then inserted into snap ring groove 50 in the nut body. The snap ring serves to retain the pins and does not allow the pins to fall out of the assembly.

If the nut assembly requires adjustment to align the holes, the nut 12 can be backed off and readjusted, or tightened further, to within torque or preload limits of the assembly, and stopped where a set of holes 22 of the nut align with the holes 30 in the washer. A maximum adjustment of 3 degrees radially from the original setting or an advancement (or loosening) of the nut (along the centerline of the threads) by no more than about 0.000463 inches (0.01176 mm) may be required.

After readjusting, the two pins 14 are assembled in opposing (and aligned) holes 22, 30 and the snap ring 18 is applied or inserted into the snap ring groove in the nut body to retain the pins.

Bearing adjustment and/or tightening specifications always have a tolerance that will allow this fine adjustment to obtain optimal bearing life or joint integrity.

The above noted adjustment features are calculated for a part that has 18 threads per inch (TPI) (2.548 inch—18 TPI). Parts having threads that are different in pitch may require different, but similar, hole patterns.

With a part having 18 TPI the nut will advance about 0.055555 inch per 360 degrees of rotation. If the part is turned about 15 degrees (which matches hole spacing in the lock washer) the nut will advance about 0.002315 inch. The spacing of the holes on the flange of the locknut is about 18 degrees (i.e., 3 degrees different than the lock washer). The holes on both the washer and the locknut of a given thread will always be on the same bolt circle, which allows the holes to align and the locking pins to be inserted. The 3 degree difference allows for a maximum adjustment opposing pin alignment of 3 degrees with a maximum nut advancement of only 0.000463 inches (i.e., about 0.0005 inches).

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the above description or the equivalents thereof.

1. A multi-part locking nut assembly, comprising:
a nut having a raised center portion and a flange having a plurality of holes therethrough:
a washer having a protrusion which is matingly received by a notch in an associated spindle; said washer having a plurality of holes therethrough; and at least one locking pin which is slidably received by one of said plurality of holes of said nut and one of said plurality of holes of said washer; and a resilient biasing member which retains said at least one locking pin in place.

2. The locking nut assembly of claim 1, wherein said nut raised center portion comprises internal threads.

3. The locking nut assembly of claim 1, wherein said nut is fabricated from metal with an HRC of 28-32.

4. The locking nut assembly of claim 1, wherein said raised portion comprises at least one notch for receiving an associated tightening tool.

5. The locking nut assembly of claim 1, wherein said protrusion of said washer is received by said notch of said associated spindle to prevent rotational movement of said washer.

6. The locking nut assembly of claim 1, wherein at least one of said openings of said nut aligns with at least one of said openings of said washer so that said locking pin can slide through said holes retaining said nut and said washer together.

7. The locking nut assembly of claim 1, wherein said resilient biasing member comprises a snap ring having opposed ends which are resiliently biased to a closed position.

8. The locking nut assembly of claim 7, wherein said snap ring opposed ends comprise openings for prying said ends to an open position.

9. The locking nut assembly of claim 8, wherein said snap ring comprises a plurality of notches and ridges for facilitating prying said snap ring to an open position.

10. The locking nut assembly of claim 1, wherein said at least one locking pin comprises a first locking pin and a second locking pin which are inserted into two of said plurality of holes of said nut and said washer.

11. A method of assembling a lock nut, comprising:
assembling a washer on a spindle by aligning a protrusion of said washer with a groove on said spindle;
threading a lock nut onto said spindle until said nut contacts said washer;
aligning at least one hole in said nut with at least one hole in said washer;
inserting a pin through said at least one hole of said washer and said at least one hole of said lock nut; and
inserting a resilient biasing member onto said nut to retain said pin onto said nut and washer.

12. The method of claim 11, wherein said nut comprises a raised center portion having internal threads.

13. The method of claim 11, wherein said nut is fabricated from metal with an HRC of 28-32.

14. The method of claim 12, wherein said raised portion comprises at least one notch for receiving an associated tightening tool.

15. The method of claim 11, wherein said protrusion of said washer is received by said groove of said spindle to prevent rotational movement of said washer.

16. The method of claim 11, wherein said resilient biasing member comprises a snap ring having opposed ends which are resiliently biased to a closed position.

17. The method of claim 16, wherein said snap ring opposed ends comprise openings for prying said ends to an open position.

18. The method of claim 17, wherein said snap ring comprises a plurality of notches and ridges for facilitating prying said snap ring to an open position.
